(19) United States
(12) Patent Application Publication
(10) Pub. No.: US 2011/0180770 A1
(43) Pub. Date: Jul. 28, 2011

(54) Light Weight Winch

(75) Inventors: Randy C. Karambelas, Milwaukie, OR (US); Oliver Heravi, Tigard, OR (US); David Scuito, Molalla, OR (US); Robert Logston, Sandy, OR (US); Fred L. Ewer, Clackamas, OR (US)

(73) Assignee: WARN INDUSTRIES, INC., Milwaukie, OR (US)

(21) Appl. No.: 13/013,190

(22) Filed: Jan. 25, 2011

Related U.S. Application Data
(60) Provisional application No. 61/298,717, filed on Jan. 27, 2010.

(51) Int. Cl. B66D 1/14; B66D 1/12; B66D 1/02; B66D 1/30; B66D 1/48; B66D 1/22

(52) U.S. Cl. 254/344; 254/342; 254/356

(57) ABSTRACT

A winch includes a rotatable drum. A cable is wound onto the drum in one rotative direction and off the drum in a second rotative direction. A sealed axial flux permanent magnet drive motor includes a drive shaft selectively rotated by the motor in either direction of rotation. A gear train interconnects the drive shaft and the drum for rotatably driving the drum at a reduced rotative speed relative to the motor shaft. The motor can apply regenerative braking. A spring-applied electric release brake is connected to the drive shaft to apply a braking force to prevent rotation of the drum. A connecting shaft connects the gear train to the rotatable drum. The connecting shaft includes axially spaced splines that reduce the disparity in the gear train and drum centerlines to thereby reduce gyration therebetween. The drum can be made partially from carbon fiber to reduce the weight thereof.

### CROSS-REFERENCE TO RELATED APPLICATIONS

This application claims the benefit of U.S. Provisional Application No. 61/298,717, filed on Jan. 27, 2010. The entire disclosures of the above application is incorporated herein by reference.

### FIELD

The present disclosure relates to winches and more particularly to a winch design having several features to improve performance and reduce weight of the winch.

### BACKGROUND

This section provides background information related to the present disclosure which is not necessarily prior art.

Winches have been in common use for many years. In general, a long rope or cable is attached at one end to a spool and the other end is fitted with a hook or other type of attachment. The hook is attached to an object that is to be moved and the spool is rotated to wind the rope onto the spool and thereby pull the object toward the spool.

Applications for a winch generally include industrial applications and vehicular applications. Vehicular applications typically include a winch mounted to the front bumper of a vehicle, specifically, a vehicle that has four-wheel drive and is driven on off road terrain. The winch includes a rotatable drum, a cable wound onto and off of the drum, and a motor and brake mechanism that controls the drum rotation. Such a winch will be used to pull the vehicle up steep hills through mud and snow and for lowering the vehicle down steep slopes.

Winches of the nature of the present invention typically include a cable winding drum which is rotatably driven by a reversible electric or hydraulic motor or other type of power device. A speed reducing drive train is interposed between the hydraulic or electrical motor and the drum to provide torque amplification and also to reduce the typically relatively high speed of the motor. A mechanical frictional brake assembly is commonly operably interconnected to the drive train to prevent unwinding of the drum when the motor is stopped and a load is attached to the cable.

Whether used for industrial or vehicular applications, it is desirable to provide a winch with greater durability and to provide a winch with reduced weight without sacrificing durability and pulling capacity. It is further desirable to provide a controllable electromagnetic brake assembly to eliminate frictional drag and heat loss caused by conventional brake assemblies.

### SUMMARY

This section provides a general summary of the disclosure, and is not a comprehensive disclosure of its full scope or all of its features.

A winch according to the principles of the present disclosure includes a rotatable drum rotatable in both rotative directions. A cable is wound onto the drum in one rotative direction and off the drum in a second rotative direction. A sealed axial flux permanent magnet drive motor includes a drive shaft selectively rotated by the motor in either direction of rotation. A gear train interconnects the drive shaft and the drum for rotatably driving the drum at a reduced rotative speed relative to the motor shaft.

According to a further aspect of the present disclosure, a spring applied electric release brake is connected to the drive shaft to apply a braking force to prevent rotation of the drum. The spring applied electric release brake can be operated simultaneously with the drive motor to release the brake when the motor is operated and to engage the brake when the motor is turned off.

According to a further aspect of the present disclosure, a controlled electromagnetic brake eliminates undesirable frictional drag as heat loss inherent in the conventional brake assemblies. Hence, when the cable is wound off the drum under the load, the motor will act as a generator that will recharge the vehicle supply batteries. Conversion of heat loss to useful electrical energy by regenerative braking is a further aspect of the present disclosure.

According to a further aspect of the present disclosure, the gear train interconnecting the drive shaft and the drum includes at least one planetary gear set including a sun gear, a ring gear and a planet carrier supporting a plurality of planet gears in meshing engagement with the ring gear and the sun gear. A connecting shaft having first external splines is connected with the planet carrier and second external splines connected to the drum, with the first and second external splines being axially spaced from each other.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a longitudinal cross-sectional view of a winch according to the principles of the present disclosure;

FIG. 2 is an enlarged cross-sectional view of the gear train and end housing shown in FIG. 1;

FIG. 3 is a cross-sectional view of the brake mechanism according to the principles of the present disclosure;

FIG. 4 is an exploded plan view of the winch showing the motor and brake housing disassembled from the remainder of the winch;

FIG. 4A is a partial cross-sectional view illustrating the airflow path through the motor housing and fan blower for cooling the motor;

FIG. 4B is a partial cross-sectional view showing an alternative airflow path through the motor housing and fan blower;

FIG. 5 is a cross-sectional view of an alternative gear train design according to the principles of the present disclosure;

FIG. 6 is an end view of the gear train shown in FIG. 5;

FIG. 7 is a perspective view of the end housing and gear train shown in FIG. 5;

FIG. 8 is a perspective view of a “dog-bone” shaped connecting shaft according to the principles of the present disclosure;

FIG. 9 is a cross-sectional view of the “dog-bone” shaped connecting shaft shown in FIG. 8;

FIG. 10 is an exemplary rotatable drum being formed at least partially from carbon fiber according to the principles of the present disclosure;

FIG. 11 is an end view of the rotatable drum shown in FIG. 10;

FIG. 12 is a cross-sectional view of an optional gear train housing that is connected to the brake housing according to the principles of the present disclosure;

FIG. 13 is a schematic diagram of the electronic controls for controlling operation of the winch motor; and

FIG. 14 is a schematic diagram of the electronic controls for providing regenerative energy to the battery of the winch system.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

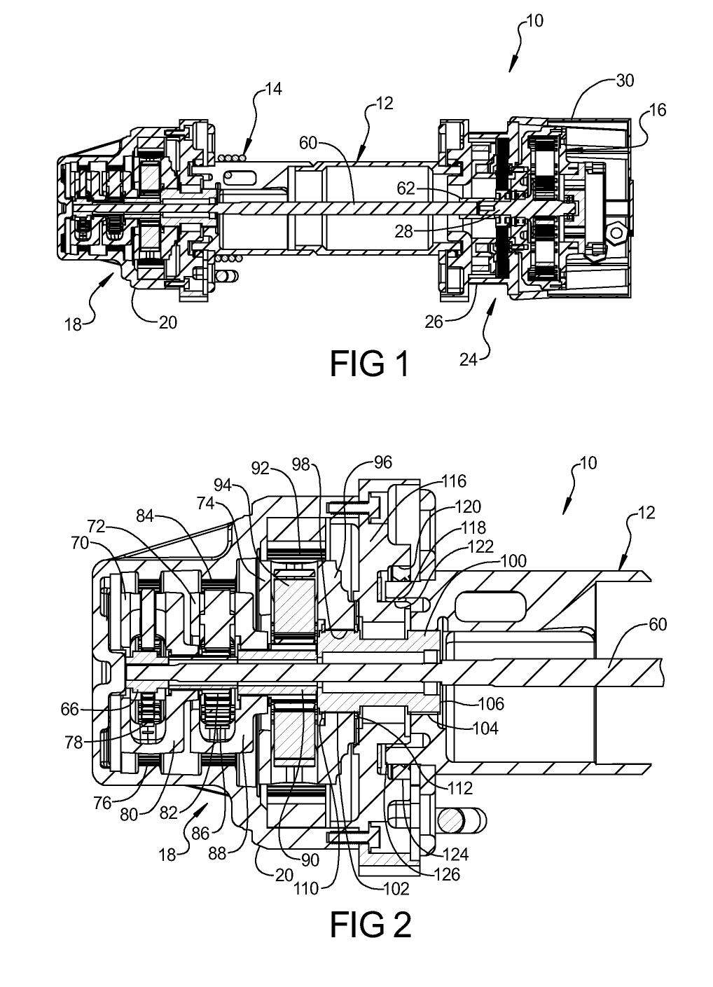

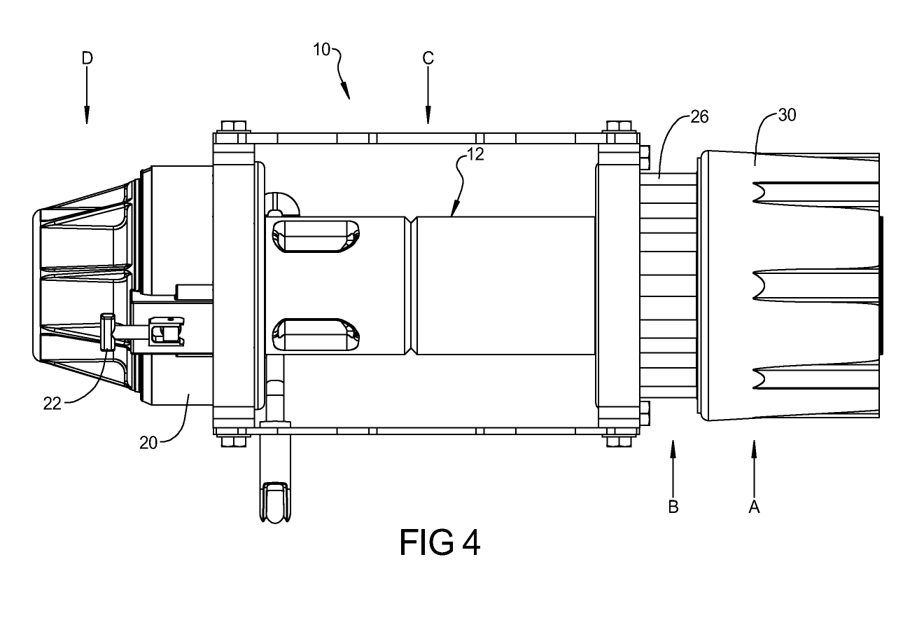

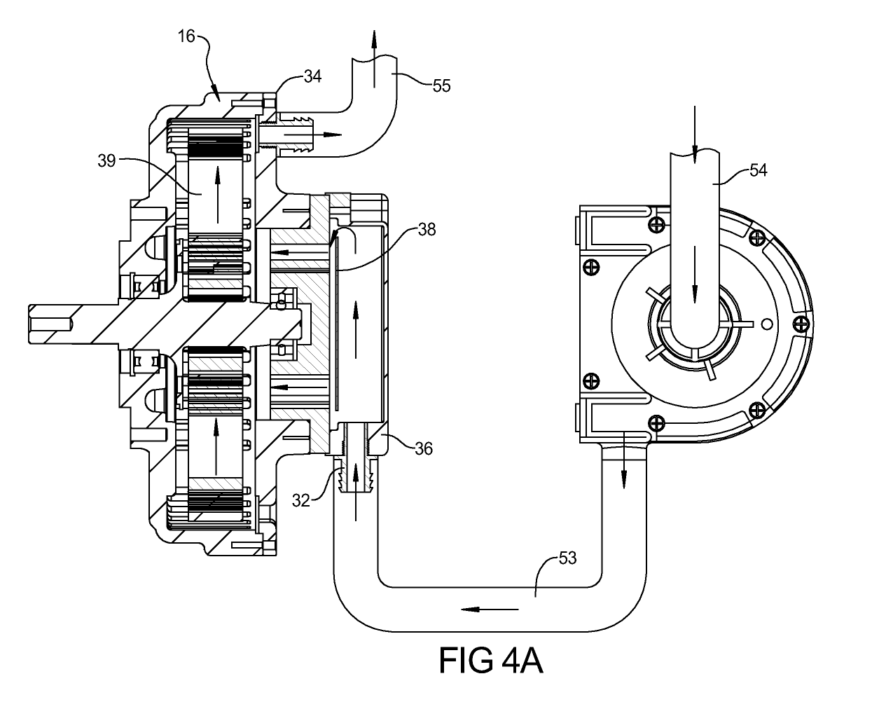

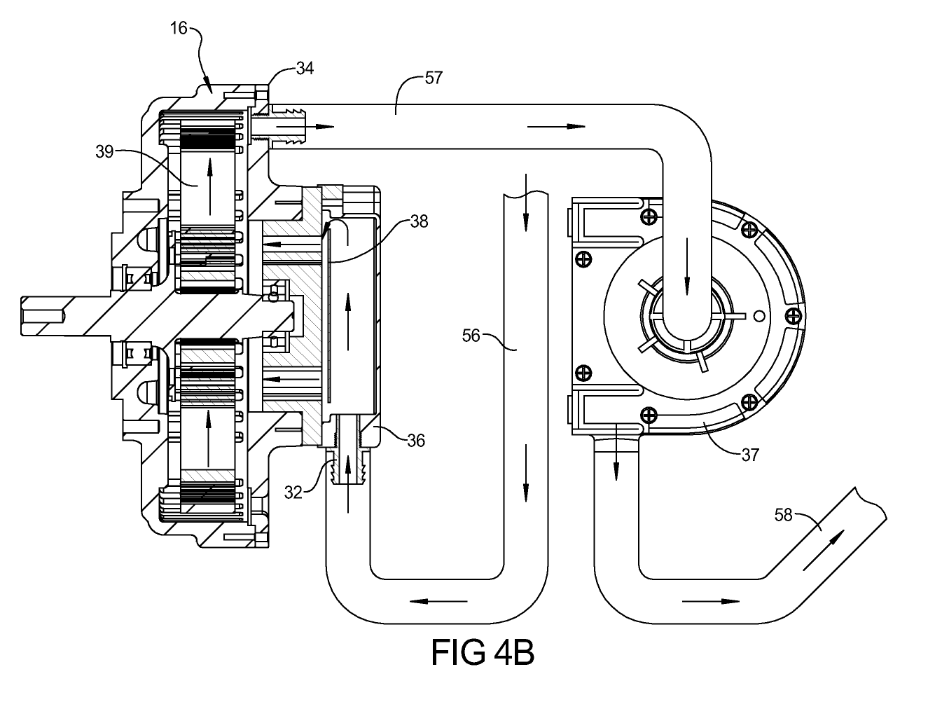

Refer now to FIG. 1 of the drawings which illustrates a winch 10 that is suited for industrial use or for mounting to a vehicle (not shown) such as a four-wheel drive pickup or the like. The winch 10 has a rotatable hollow cylindrical drum 12 for winding and unwinding a length of rope or cable 14 on its periphery. The drum 12 may be positively driven in either direction by a reversing motor 16. The motor 16 is coupled to the drum 12 by a speed reducing gear train 18 contained in the end housing 20. The gear train 18 reduces the rotational speed of the drum with respect to the motor rotational speed (and thus, provides torque amplification). A shift lever 22 (FIG. 4) is provided to disengage the gear train 18 so that the drum 12 may be rotated free of the gear train 18 so that cable 14 may be played out off the drum 12 manually for example. A brake 24 is provided within a brake housing 26.

The motor 16 can be an axial flux permanent magnet drive motor of the type that is commercially available from Perm Motor GMBh in Schonau, Germany. The motor 16 is additionally disposed within a sealed housing 30 with cooling ports including an inlet port 32 and an outlet port 34 that allow the passage of cooling air into the motor housing 30 for cooling the motor 16.

The winch industry generally uses series wound and permanent magnet motors with the rotor radially arranged within the stator. These conventional motors typically have a 25-30 percent efficiency, whereby for a motor having an example of 5000 watts, 3000 watts is typically lost to heat. In contrast, the axial flux-type motor, according to the principles of the present disclosure, is up to 80 percent efficient, thereby greatly reducing the motor losses that are experienced. Further, the axial flux-type motor 16 is lighter in weight than conventional motors used in winches. The motor 16 is disposed within the sealed housing 30 that can be die cast from an aluminum alloy that allows for good heat transfer in addition to the ports 32, 34 that allow air circulation for further cooling. The sealed die-cast aluminum housing 30 also provides reduced weight as compared to conventional motor housings.

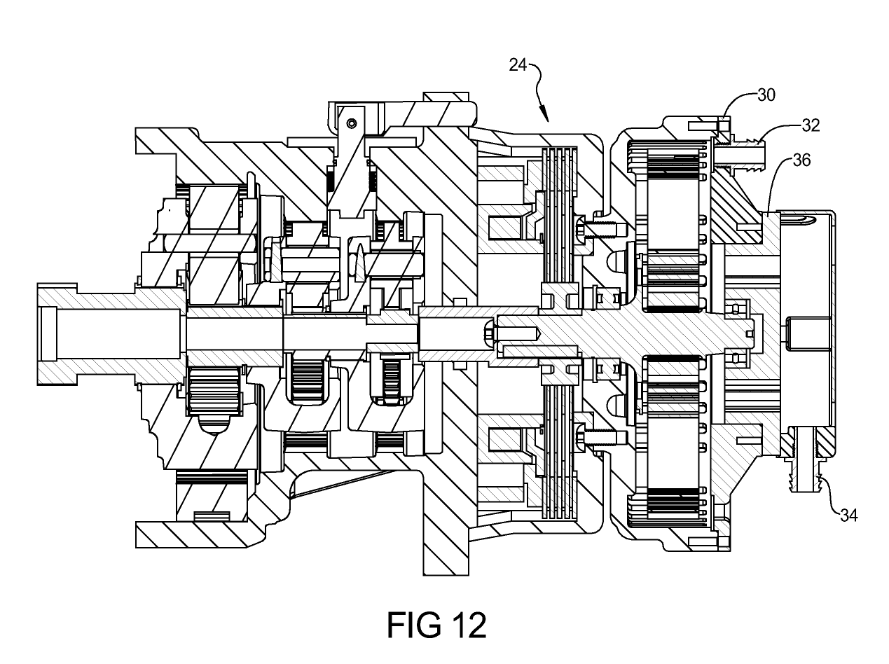

As shown in FIGS. 4 and 12, the inlet port 32 and outlet port 34 can be provided as an extension housing 36 that extends from the die cast aluminum housing 30. As shown in FIG. 4A, the inlet port 32 can be connected via tubing 53 to a remote fan mechanism 37 that forces air through the motor housing 30. The fan 37 can be provided with an inlet pipe 54 which can be provided with a filter and/or can be disposed in such a location (such as under the hood of a vehicle) that is isolated from dirt, debris, and fluids so as to protect the motor 16 from contaminants. The outlet port 34 can be connected to a pipe 56 which is located to be isolated from contaminants. Ports 32, 34 are placed such that air is forced through the motor brush assembly 38 and then through the armature 39 before exiting the motor housing 30.

As an alternative arrangement, as shown in FIG. 4B, the fan 37 can draw air through an inlet pipe 56 connected to the air inlet port 32 of the extension housing 36 with the air outlet port 34 connected to the inlet of the fan via a pipe 57 and the fan outlet flowing the air through an outlet pipe 58. The inlet and outlet pipes 56, 58 can be located in an area of a vehicle that is isolated from debris and/or water.

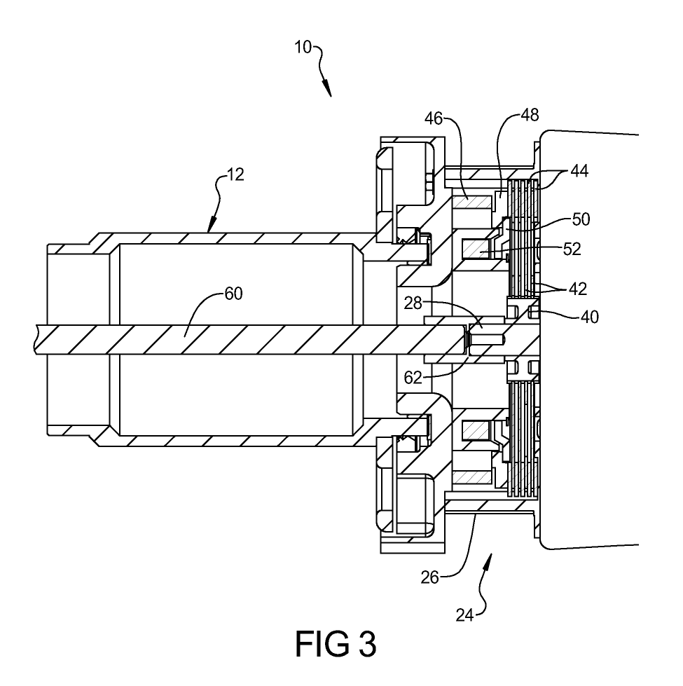

The brake assembly 24 can be a spring applied electric release brake as most clearly shown in FIG. 3. The spring applied electric release brake 24 includes a brake hub 40 having a plurality of inner brake disks 42 splined thereto. The inner brake disks 42 that are splined to the brake hub 40 are interleaved with outer brake disks 44 that are provided in splined connection to the brake housing 26. An engagement spring 46 is disposed within the housing 26 and presses against a pressure plate 48 that is disposed against the brake disks 42, 44. An armature 50 opposes the pressure plate 48. An electromagnet 52 is opposed to the armature 50, and when energized, causes the armature 50 to move in a leftward direction, as shown in FIG. 3, so as to oppose the biasing force of the engagement spring 46 to release the pressure plate 48 from applying braking force to the brake disks 44, 42.

Activation of the electromagnet 52, as well as the electric motor 16, is controlled by a control unit that can be responsive to user input. The control unit can include dedicated circuits, computer based activation control, or other known control arrangements. Upon activation of the electric motor 16, the electromagnet 52 is activated to release the brake 24 so that the motor 16 can turn the drive shaft 28. Upon deactivation of the electric motor 16, the electromagnet 52 is deactivated such that the engagement spring 46 biases the pressure plate 48 against the brake disks 42, 44 in order to apply a braking force for the drive shaft 28 to prevent rotation of the drum 12.

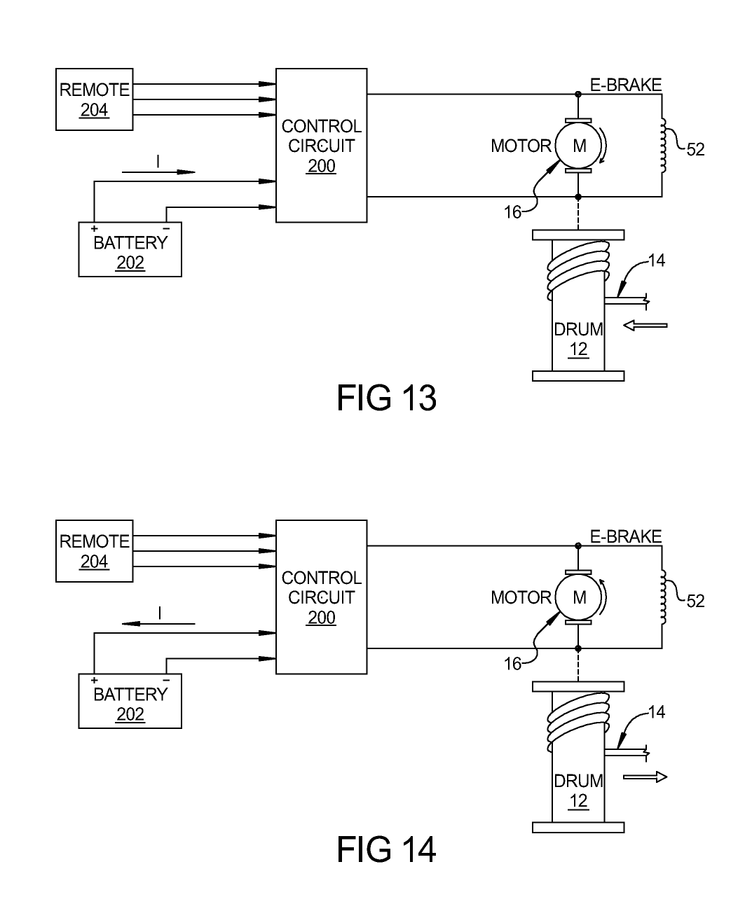

The winch 10 can be provided with regenerative braking, as illustrated in FIGS. 13 and 14. With reference to the circuit diagram of FIG. 13, a control circuit 200 is connected to the winch motor 16 and electromagnet 52 in parallel for supplying current from the battery 202. A remote control unit 204 is connected to the control circuit 200 for providing control signals to the control circuit for rotating the drum 12 in clockwise or counter clockwise directions to either wind or unwind the cable 14 from the drum 12. When the cable 14 is being wound onto the drum 12, as illustrated in FIG. 13, the battery 202 supplies current Ito the motor 16 and electromagnet 52. When the cable is being unwound from the drum under load, as illustrated in FIG. 14, the load forces on the cable 14 rotate the drum 12 and motor 16 whereby the axial flux permanent magnet motor 16 acts as a generator, thus charging the battery. The axial flux permanent magnet motor 16 provides controlled braking when the cable is being unwound, wherein the braking force is converted into useful electrical energy instead of the heat loss associated with conventional friction brakes.

It should be understood that the brake assembly 24 can be utilized with other motors and with other designs of winches other than the specific motor and winch design disclosed herein.

The motor drive shaft 28 is coupled to an intermediate drive shaft 60 by a coupler 62 that can have a non-rotatable mating engagement with the drive shaft 28 and intermediate drive shaft 60 such as by a hex-shaped, splined, or other non-rotatable connection therebetween. The intermediate drive shaft 60 extends axially through the rotatable drum 12 and end housing 20 which houses the gear train 18. The intermediate drive shaft 60 can be connected to a sun gear 66 non-rotatably fixed on an end thereof, as best illustrated in FIG. 2. The sun gear 66 provides an input into the gear train 18 which can include multiple gear sets for rotatably driving the drum at a reduced rotative speed relative to the motor shaft 28.

In the embodiment shown in FIGS. 1 and 2, the gear train 18 includes a first planetary gear set 70, a second planetary gear set 72, and a third planetary gear set 74. Generally, as is well known in the art, the first planetary gear set 70 includes a sun gear 66, a ring gear 76, and a plurality of planetary gears 78 that are in meshing engagement with the sun gear 66 and ring gear 76. The planetary gears 78 are supported by planetary carrier 80 that is drivingly connected to a sun gear 82 of the second planetary gear set 72. Ring gear 76 of the first planetary gear set 70 is fixed to the end housing 20. The second planetary gear set 72 includes the second sun gear 82, a second ring gear 84 which can be fixed to the housing 20, and a plurality of planetary gears 86 that are in meshing engagement with the sun gear 82 and ring gear 84 of the second planetary gear set 72. A second planetary carrier 88 supports the plurality of planetary gears 86 and is drivingly connected to a third sun gear 90 of the third planetary gear set 74. The third planetary gear set includes the third sun gear 90, a third ring gear 92, and a third plurality of planetary gears 94 that are held in meshing engagement with the third sun gear 90 and third ring gear 92 by a planetary carrier 96.

In the embodiment shown in FIG. 2, the third planetary gear set 74 is provided with a ring gear 92 that is engageable to the end housing 20 by a shifting mechanism 22 (FIG. 4), that is capable of non-rotatably locking the third ring gear 92 to the end housing 20 and unlocking the third ring gear 92 from the end housing 20 to allow the drum 12 to free spool so that the cable can be manually pulled from the drum 12. The third planetary carrier 96 includes internal splines 98 that are engaged with external splines 102 of a “dog-bone” shaped connecting shaft 100. The external splines 102 of the connecting shaft 100 are axially spaced from a second set of external splines 104 that are provided on a second end of the connecting shaft 100. The second set of external splines 104 are engaged with internal splines 106 of the rotatable drum 12. The “dog-bone” shaped connecting shaft 100 spaces the splined features 102, 104 apart to reduce the steering effect thereby reducing the disparity in the gear train and drum centerlines to reduce gyration therebetween. An axial distance between the spline sections 102, 104 can be at least 1.0, and more particularly, at least 1.5 spline pitch diameters apart to provide a significant reduction in the gyration effect. It is noted that although spline sections 102, 104 are shown as separate spaced apart splines, the splines can be continuous along the length of the connecting shaft so long as the connection at opposite ends thereof are spaced axially at least 1.0 spline pitch diameters apart, a significant reduction in the gyration effect can be achieved.

The first set of external splines 102 can be provided with recessed grooves 102a, 102b (FIG. 9) for receiving retainer clips 110, 112 that secure the connecting shaft 100 to the planetary carrier 96. The connecting shaft 100 extends through a hole in a drum support plate 116. The drum support plate 116 includes inner and outer bearing support surfaces 118, 120 that support inner and outer bearings 122, 124, respectively, for supporting an axially extending flange 126 of the rotatable drum 12.

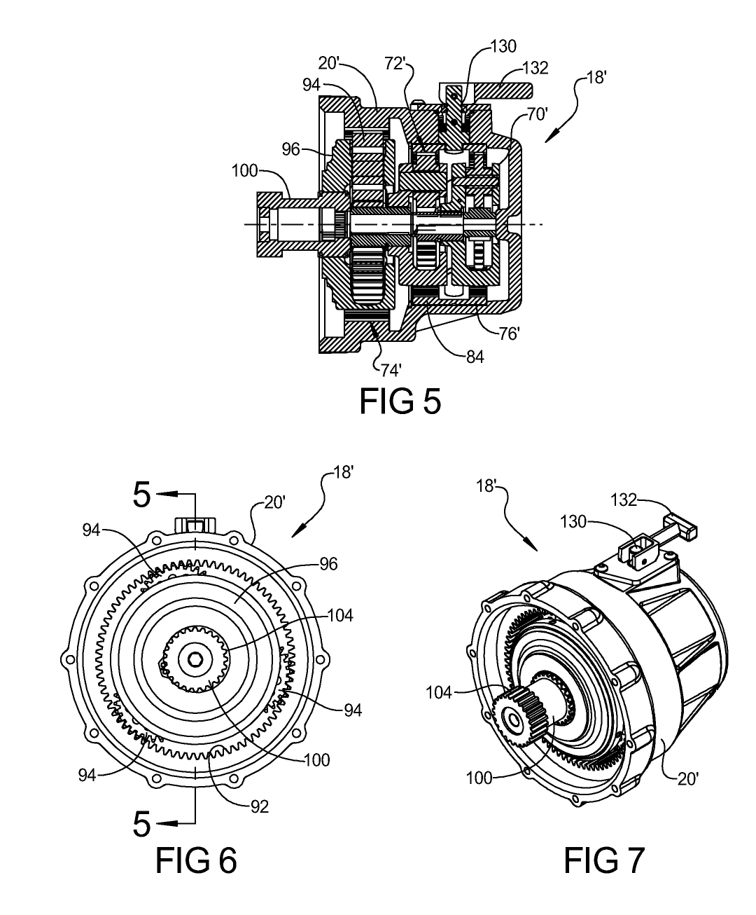

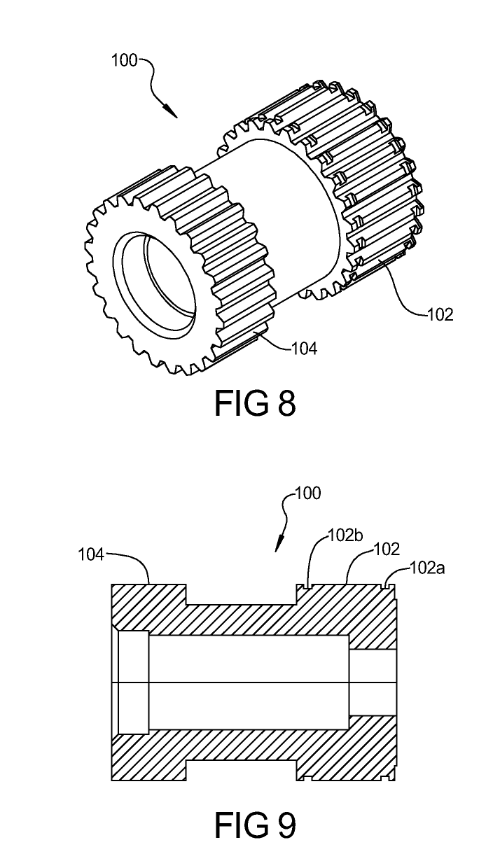

FIGS. 5-7 illustrate an alternative gear train design 18′ similar to the gear train 18, with the gear train 18′ including the first and second ring gears 76′, 84′ being rotatably mounted within the housing 20′, and having a locking pin 130 adapted to non-rotatably engage the first and second ring gears 76′, 84′ to the housing 20′ in order to prevent rotation thereof while the lever 132 can be pivoted toward a disengaged position in order to disengage the locking pin 130 from the ring gears 76′, 84′ to allow free spooling of the rotatable drum 12. It is noted that the arrangement of the planetary gear sets 70′, 72′, and 74′ are otherwise substantially the same as the first, second, and third planetary gear sets 70, 72, 74, as described previously.

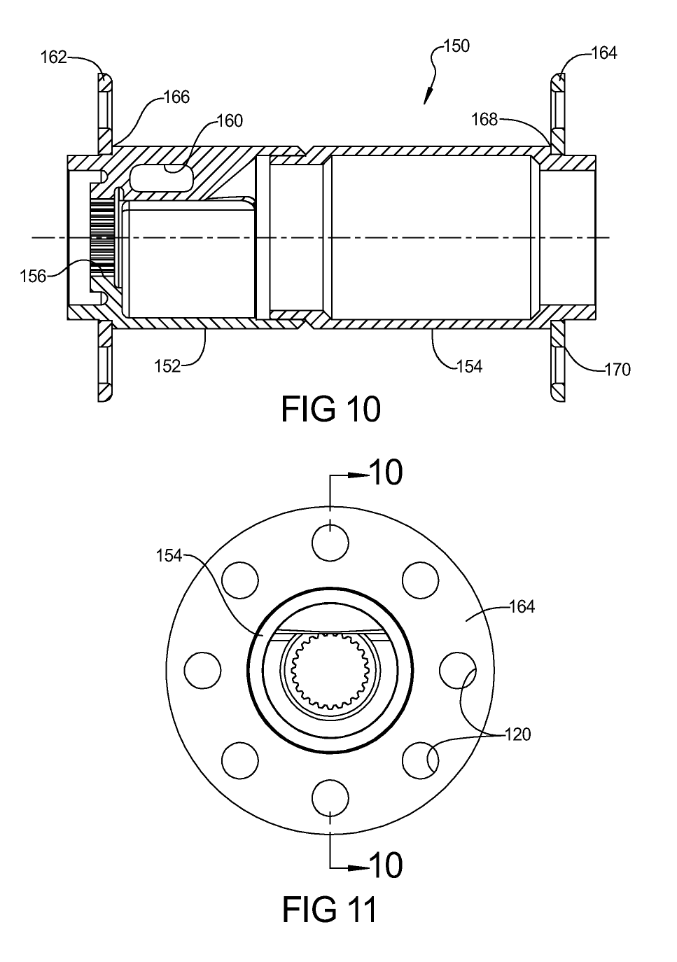

The rotatable drum can have an alternative configuration as shown by the drum 150 in FIGS. 10 and 11. The drum 150 can include a metal drum section 152 and a carbon fiber drum section 154. The metal drum section 152 can include an internal spline segment 156 for engagement with the connector shaft 100. The metal drum section 152 can also include an anchor portion 160 for receiving an end of the cable for attachment to the rotatable drum. The carbon fiber drum segment 154 is made from carbon fiber that is embedded in resin and formed in the shape of a cylinder. The carbon fiber drum segment 154 is secured to the metal drum segment 152 by adhesives or other fastening methods. As shown in FIG. 10, additional end flange plates 162, 164 can be secured to the metal drum segment 152 and the carbon fiber drum segment 154 against shoulders 166, 168. By way of non-limiting example, end flange plates 162, 164 can be secured to the drum segments 152, 154 using an adhesive. For torque transmission, an anti-rotation feature such as a drive spline or pins may be used. The use of carbon fiber for the end flange plates 162, 164, as well as the carbon fiber drum segment 154, provides a significant weight reduction for the drum 150, as compared to conventional rotatable drums used in winches. The flange segments 162, 164 can be provided with weight reducing holes 170. Weight reduction of the carbon fiber drum with metal inserts over a drum made from alloy steel will be approximately 60%.

As shown in FIGS. 4 and 12, the winch 10 can be formed by separate modules that can be secured together using quick connect features or other fasteners. The modules can include a motor module A, a brake module B, a drum module C, and a reduction gear module D. The use of different modules facilitates the assembly and maintenance of the winch in the field. Further, the use of quick connect fasteners such as toggle clamps facilitates the easy replacement of a module or the break down of the winch that can then be carried or transported as lighter weight, easier to carry, individual components. Furthermore, with minor modification, the winch can be provided with the reduction gear module D on either side of the drum module C, as illustrated by FIG. 12.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. A winch, comprising:
a rotatable drum rotatable in both rotative directions;
a cable wound onto the drum in a first rotative direction and off the drum in a second rotative direction;
an axial flux permanent magnet drive motor having a drive shaft selectively rotated by the motor in either direction of rotation; and
a gear train interconnecting the drive shaft and the drum for rotatably driving the drum at a reduced rotative speed relative to the motor shaft.

2. The winch according to claim 1, wherein said axial flux permanent magnet drive motor is disposed within a sealed motor housing that is in communication with a fan for forcing air through said sealed motor housing.

3. The winch according to claim 2, wherein said fan is remotely located from said motor housing.

4. The winch according to claim 2, wherein an extension housing is connected to said motor housing, and a brush plate is disposed within said extension housing and is cooled by air that is forced through said motor housing and said extension housing by said fan.

5. The winch according to claim 4, wherein said brush plate is disposed upstream of said motor for cooling by said air prior to said motor.

6. The winch according to claim 1, wherein said axial flux permanent magnet drive motor is connected to a control circuit and to a battery power source and said axial flux permanent magnet drive motor provides regenerative braking by supplying current to said battery when said cable is being unwound from said drum under load.

7. A winch, comprising:
a rotatable drum rotatable in both rotative directions;
a cable wound onto the drum in a first rotative direction and off the drum in a second rotative direction;
a drive motor having a drive shaft selectively rotated by the motor in either direction of rotation;
a gear train interconnecting the drive shaft and the drum for rotatably driving the drum at a reduced rotative speed relative to the motor shaft; and
a spring applied electric release brake connected to said drive shaft.

8. The winch according to claim 7, wherein said cable is a synthetic rope.

9. The winch according to claim 7, further comprising a controller for controlling operation of said drive motor and said electric release brake whereby when said drive motor is energized for rotating said drive shaft, said controller simultaneously energizes said electric release brake to release the braking applied to the drive shaft.

10. The winch according to claim 7, further comprising a controller for controlling operation of said drive motor and said electric release brake whereby when said drive motor is de-energized, said controller de-energizes said electric release brake to allow the electric release brake to apply braking force to said drive shaft.

11. The winch according to claim 7, wherein said spring applied electric release brake includes at least one brake disk which engages with a brake hub attached to said drive shaft and at least one brake disk non-rotationally fixed to a brake housing and frictionally engaging said at least one brake disk engaged with said brake hub, a pressure plate with an engagement spring provided for applying pressure against said brake disks, an armature opposing said pressure plate and an electromagnet opposing said armature to oppose an engagement force of said engagement spring when said electromagnet is energized to release a brake force applied by said electric release brake.

12. A winch, comprising:
a rotatable drum rotatable in both rotative directions;
a cable wound onto the drum in a first rotative direction and off the drum in a second rotative direction;
a drive motor having a drive shaft selectively rotated by the motor in either direction of rotation; and
a gear train interconnecting the drive shaft and the drum for rotatably driving the drum at a reduced rotative speed relative to the motor shaft, said gear train including at least one planetary gear set including a sun gear, a ring gear and a planet carrier supporting a plurality of planet gears in meshing engagement with said ring gear and said sun gear, a connecting shaft having first external spline portions connected with said planet carrier and second external spline portions connected to said drum, said first and second external spline portions having engagement locations that are axially spaced from each other.

13. The winch according to claim 12, wherein said first external spline portions include recessed annular grooves for receiving retaining rings that engage said planet carrier.

14. The winch according to claim 12, wherein said engagement locations of said first external spline portions are spaced from said second external spline portions by at least one pitch diameter of one of said first and second external spline portions.

15. The winch according to claim 12, wherein said first external spline portions and said second external spline portions are separately formed on said connecting shaft.

16. The winch according to claim 12, wherein said drive motor is an electric motor.

17. A winch, comprising:
a rotatable drum rotatable in both rotative directions, said rotatable drum being formed at least partially from carbon fiber;
a cable wound onto the drum in a first rotative direction and off the drum in a second rotative direction;
a drive motor having a drive shaft selectively rotated by the motor in either direction of rotation; and
a gear train interconnecting the drive shaft and the drum for rotatably driving the drum at a reduced rotative speed relative to the motor shaft.

18. The winch according to claim 17, wherein said rotatable drum includes a first drum end section made from a metal material and defining an internal spline segment for engagement with said gear train and an anchor portion for receiving an end of said cable for attachment to said rotatable drum, and a second drum end segment made from said carbon fiber and secured to said first drum end segment.

19. The winch according to claim 18, wherein said first drum end section is connected to said second drum end section by an adhesive.

20. The winch according to claim 17, wherein said rotatable drum includes at least one shoulder against which an end flange plate is secured.

21. The winch according to claim 20, wherein said end flange plate is made from carbon fiber.
